(19) United States
(12) Patent Application Publication
(10) Pub. No.: US 2012/0268557 A1
(43) Pub. Date: Oct. 25, 2012

(54) 3D IMAGE PROCESSING APPARATUS AND METHOD FOR ADJUSTING 3D EFFECT THEREOF

(75) Inventors: Chang-won KIM, Gwangju-si (KR); Da-le YIM, Suwon-si (KR)

(73) Assignee: SAMSUNG ELECTRONICS CO., LTD., Suwon-si (KR)

(21) Appl. No.: 13/243,262

(22) Filed: Sep. 23, 2011

(30) Foreign Application Priority Data
Apr. 20, 2011 (KR) 10-2011-0036973

(51) Int. Cl. H04N 7/025; H04N 13/00

(52) U.S. Cl. 348/42; 348/E13.001; 348/E07.017

(57) ABSTRACT

Provided are a three-dimensional (3D) image processing apparatus and a method of adjusting a 3D effect thereof. The 3D image processing apparatus includes: a meta data analyzer which analyzes meta data about an input video signal and extracts, from the meta data, at least one auxiliary data usable in adjusting 3D effect information of the input video signal; a meta data processor which calculates a 3D effect adjusting value for adjusting the 3D effect information on the basis of the at least one extracted auxiliary data; and a 3D effect adjuster which adjusts the 3D effect information on the basis of the calculated 3D effect adjusting value, and adjusts the input video signal to have a 3D effect based on the adjusted 3D effect information.

### CROSS-REFERENCE TO RELATED APPLICATION

This application claims priority from Korean Patent Application No. 10-2011-0036973, filed on Apr. 20, 2011 in the Korean Intellectual Property Office, the disclosure of which is incorporated herein by reference in its entirety.

### BACKGROUND

1. Field

Apparatuses and methods consistent with exemplary embodiments relate to a three-dimensional (3D) image processing apparatus and a method of adjusting a 3D effect thereof, and more particularly to a 3D image processing apparatus in which meta data is used for adjusting a 3D effect of an input video signal, and a method of adjusting the 3D effect thereof.

2. Description of the Related Art

A related art image processing apparatus uses meta data about a video signal in order to enhance picture quality of a two-dimensional (2D) video signal, or uses the meta data about a video signal in order to generate a depth map for generating a three-dimensional (3D) video signal from a 2D video signal. However, the related art image processing apparatus cannot adjust a 3D effect recognized by a user by adjusting in detail the depth map of an input video signal through the meta data of the video signal.

### SUMMARY

Accordingly, one or more exemplary embodiments provide a three-dimensional (3D) image processing apparatus and a method of adjusting a 3D effect thereof, in which various kinds of meta data about a video signal are used and a depth map about an input video signal is adjusted in accordance with attributes of various kinds of meta data, thereby adjusting the 3D effect to be recognized by a user.

According to an aspect of an exemplary embodiment, there is provided a 3D image processing apparatus including: a meta data analyzer which analyzes meta data about an input video signal and extracts, from the meta data, auxiliary data usable in adjusting 3D effect information of the input video signal; a meta data processor which calculates a 3D effect adjusting value for adjusting the 3D effect information on the basis of the extracted auxiliary data; and a 3D effect adjuster which adjusts the 3D effect information on the basis of the calculated 3D effect adjusting value, and adjusts the input video signal to have a 3D effect based on the adjusted 3D effect information.

The meta data processor may calculate the 3D effect adjusting value in accordance with an attribute of the auxiliary data.

The meta data processor may calculate a plurality of 3D effect adjusting values corresponding to a plurality of auxiliary data if the plurality of auxiliary data is extracted by the meta data analyzer, calculate a final 3D effect adjusting value by weighting and adding the plurality of calculated 3D effect adjusting values, and transmit the final 3D effect adjusting value to the 3D effect adjuster.

The auxiliary data may include at least one of content information corresponding to the input video signal, stereo camera information about the input video signal, and image-related information about the input video signal.

The content information may include at least one of genre information about contents, story line information about contents, and viewing age information about contents.

The stereo camera information may include at least one of distance information between stereo cameras, lens information of a stereo camera, focusing information of a stereo camera, lighting information of a stereo camera, and exposure information of a stereo camera.

The image-related information may include at least one of scene change information of the input video signal, key frame information of the input video signal, video attribute information of the input video signal, and minimum and maximum depth value information of the input video signal.

The meta data processor may generate a depth map of the input video signal on the basis of the stereo camera information if the auxiliary data includes the stereo camera information.

The meta data processor may calculate a 3D effect adjusting value of a key frame if the auxiliary data includes the key frame information, and estimate a 3D effect adjusting value of a non-key frame on the basis of the calculated 3D effect adjusting value of the key frame.

The 3D effect information may include a depth map of the input video signal, the auxiliary data may include a depth adjusting data usable in adjusting the depth map, and the auxiliary data adjusting value may include a depth adjusting value for adjusting the depth map.

According to an aspect of another exemplary embodiment, there is provided a method of adjusting a 3D effect of a 3D image processing apparatus, the method including: analyzing meta data about an input video signal and extracting auxiliary data usable in adjusting 3D effect information of the input video signal from the meta data; calculating a 3D effect adjusting value for adjusting the 3D effect information on the basis of the extracted auxiliary data; and adjusting the 3D effect information on the basis of the calculated 3D effect adjusting value, and adjusting the input video signal to have a 3D effect based on the adjusted 3D effect information.

The calculating the 3D effect adjusting value may include calculating the 3D effect adjusting value in accordance with an attribute of the auxiliary data.

The calculating the 3D effect adjusting value may include calculating a plurality of 3D effect adjusting values corresponding to a plurality of auxiliary data if the plurality of auxiliary data is extracted in the extracting the auxiliary data, and calculating a final 3D effect adjusting value by weighting and adding the plurality of calculated 3D effect adjusting values.

The auxiliary data may include at least one of content information corresponding to the input video signal, stereo camera information about the input video signal, and image-related information about the input video signal.

The content information may include at least one of genre information about contents, story line information about contents, and viewing age information about contents.

The stereo camera information may include at least one of lens position information of a stereo camera, focusing information of a stereo camera, lighting information of a stereo camera, and exposure information of a stereo camera.

The image-related information may include at least one of scene change information of the input video signal, key frame information of the input video signal, video attribute information of the input video signal, and minimum and maximum depth value information of the input video signal.

The method may further include generating a depth map of the input video signal on the basis of the stereo camera information if the auxiliary data includes the stereo camera information.

The calculating a 3D effect adjusting value may include calculating a 3D effect adjusting value of a key frame if the auxiliary data includes the key frame information, and estimating a 3D effect adjusting value of a non-key frame on the basis of the calculated 3D effect adjusting value of the key frame.

The 3D effect information may include a depth map of the input video signal, the auxiliary data may include a depth adjusting data usable in adjusting the depth map, and the auxiliary data adjusting value may include a depth adjusting value for adjusting the depth map.

According to an aspect of another exemplary embodiment, there is provided a method of adjusting a 3D effect of a 3D image processing apparatus, the method including: calculating a 3D effect adjusting value for adjusting 3D effect information of a video signal according to auxiliary data comprised in meta data corresponding to the video signal; and adjusting the 3D effect information according to the calculated 3D effect adjusting value, and adjusting the input video signal to have a 3D effect based on the adjusted 3D effect information.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a control block diagram of a three-dimensional (3D) image processing apparatus according to an exemplary embodiment;

FIG. 2 is a control block diagram of a meta data processor included in the 3D image processing apparatus of FIG. 1;

FIGS. 3A and 3B are views showing an exemplary embodiment of a processing operation of the meta data processor of FIG. 2;

FIG. 4 is a view showing another exemplary embodiment of the processing operation of the meta data processor of FIG. 2;

FIG. 5 is a view showing still another exemplary embodiment of the processing operation of the meta data processor of FIG. 2; and

FIG. 6 is a flowchart showing a control operation of the 3D image processing apparatus of FIG. 1.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout. Expressions such as “at least one of,” when preceding a list of elements, modify the entire list of elements and do not modify the individual elements of the list.

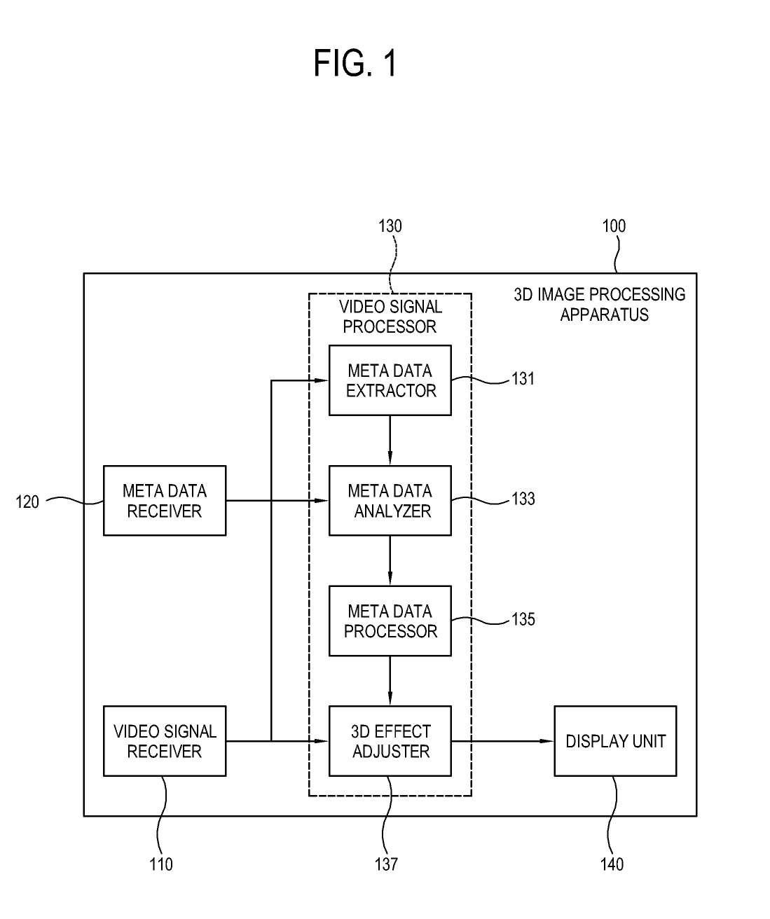

FIG. 1 is a control block diagram of a three-dimensional (3D) image processing apparatus 100 according to an exemplary embodiment.

A 3D image processing apparatus 100 in the present exemplary embodiment adjusts 3D effect information about an input video signal on the basis of meta data of the input video signal, and thus adjusts, in detail, a 3D effect to be recognized by a user, thereby maximizing the 3D effect of the input video signal. The 3D effect information contains depth map information about the input video signal, and the 3D image processing apparatus 100 in the present exemplary embodiment adjusts the depth map information on the basis of the meta data about the input video signal, thereby adjusting the 3D effect of the input video signal in more detail.

The 3D image processing apparatus 100 includes an electronic apparatus capable of processing and outputting a 3D video signal. The 3D image processing apparatus 100 may be achieved by a display apparatus that processes a 3D video signal and displays the processed 3D video signal on a display unit 140. Also, the 3D image processing apparatus 100 may be achieved by a set-top box, a Blu-ray disc (BD), a digital versatile disc (DVD) player, a game console, a computing device, etc., which do not include the display unit 140.

The 3D image processing apparatus 100 may include an electronic apparatus capable of receiving a two-dimensional (2D) video signal from an exterior and generating, processing and outputting a 3D video signal. In this case, the 3D image processing apparatus 100 may generate a depth map based on meta data, and thus generate a 3D video signal.

The 3D image processing apparatus 100 may include an electronic apparatus capable of receiving a 3D video signal from an exterior and processing and outputting the 3D video signal. In this case, if the video signal contains depth map information in the form of meta data, the depth map information is extracted and used to thereby process a 3D video signal. On the other hand, if the video signal does not contain the depth map information in the form of meta data, the 3D image processing apparatus 100 estimates a depth map from the received 3D video signal by a generally known estimation theory, and thus processes a 3D video signal on the basis of the estimated depth map.

The meta data about the input video signal may be included in the video signal and transmitted to the 3D video processing apparatus 100, or the meta data may be transmitted separately, e.g., from a separate external device (not shown), to the 3D image processing apparatus 100. In the former case, the 3D image processing apparatus 100 may further include a meta data extractor 131 that extracts the meta data from the received video signal and transmits the extracted meta data to a meta data analyzer 133. In the latter case, the 3D image processing apparatus 100 may further include a meta data receiver 120 that receives meta data about a video signal from the external device (not shown). At this time, the external device (not shown) may communicate with the 3D image processing apparatus 100 and transmit the meta data to the 3D image processing apparatus 100 if receiving a request for the meta data about the video signal from the 3D image processing apparatus 100. Such an external device (not shown) may be achieved by a server, a web server, etc.

As shown in FIG. 1, the 3D image processing apparatus 100 includes a video signal receiver 110, a meta data receiver 120, a video signal processor 130 and a display unit 140.

The video signal receiver 110 may receive a 2D video signal or a 3D video signal from an external video source (not shown). The video signal receiver 110 may receive a radio frequency (RF) signal transmitted from a broadcasting station wirelessly, or a video signal complying with composite video, component video, super video, Syndicat des Constructeurs des Appareils Radiorécepteurs et Téléviseurs (SCART), high definition multimedia interface (HDMI), etc., via a wire. Also, the video signal receiver 110 may have access to the web server (not shown) and may receive a data packet of web contents. Furthermore, the video signal receiver 110 may receive a 2D video signal containing meta data or a 3D video signal containing meta data. In this case, the video signal receiver 110 may transmit the received 2D video signal or 3D video signal containing the meta data to the meta data extractor 131.

The meta data receiver 120 may receive meta data about a 2D video signal or a 3D video signal from an external device (not shown). If the video signal receiver 110 receives a 2D video signal or a 3D video signal containing no meta data, the meta data receiver 120 may communicate with the external device and request and receive the meta data corresponding to the received video signal. The meta data receiver 120 may transmit the received meta data to a meta data analyzer 133.

The video signal processor 130 may process a video signal received by the video signal receiver 110 and meta data received by the meta data receiver 120. The video signal processor 130 may perform a general video signal process so that the received video signal can be displayed on the display unit 140. For example, the video signal processor 130 may perform decoding and encoding corresponding to various video formats, de-interlacing, frame refresh rate conversion, scaling, noise reduction for improving picture quality, detail enhancement, line scanning, etc. For example, the video signal processor 130 may process a 3D video signal so that video signals respectively corresponding to a left-eye image and a right-eye image can be alternately scanned to the display unit 140.

The video signal processor 130 may include a meta data extractor 131, the meta data analyzer 133, a meta data processor 135, and a 3D effect adjuster 137.

The meta data extractor 131 can extract meta data from a video signal and transmit the extracted meta data to the meta data analyzer 133 when receiving the video signal containing the meta data from the video signal receiver 110. If the meta data receiver 120 receives the meta data separately from transmission of the video signal, the meta data extractor 131 may be omitted.

The meta data analyzer 133 can receive meta data about a video signal received by the video signal receiver 110 through the meta data extractor 131 or the meta data receiver 120. The meta data analyzer 133 can analyze the received meta data and extract at least one auxiliary data to be used in adjusting 3D effect information of an input video signal received by the video signal receiver 110. The meta data analyzer 133 may extract a plurality of auxiliary data. The auxiliary data may include at least one of content information corresponding to a video signal received by the video signal receiver 110, stereo camera information about a 3D video signal if a video signal received by the video signal receiver 110 is the 3D video signal, and image-related information about a video signal received by the video signal receiver 110. The content information may include at least one of genre information of contents, story line information of the contents, and viewing age information of the contents. The stereo camera information may include at least one of lens position information of a stereo camera, focusing information of the stereo camera, lighting information of the stereo camera, and exposure information of the stereo camera. The image-related information may include at least one of scene change information of an input video signal, key frame information of the input video signal, video attribute information of the input video signal, and minimum and maximum depth value information of the input video signal.

Here, the 3D effect information of the input video signal may contain the depth map information about the input video signal, and the auxiliary data may contain depth adjusting data to be used in adjusting the depth map information.

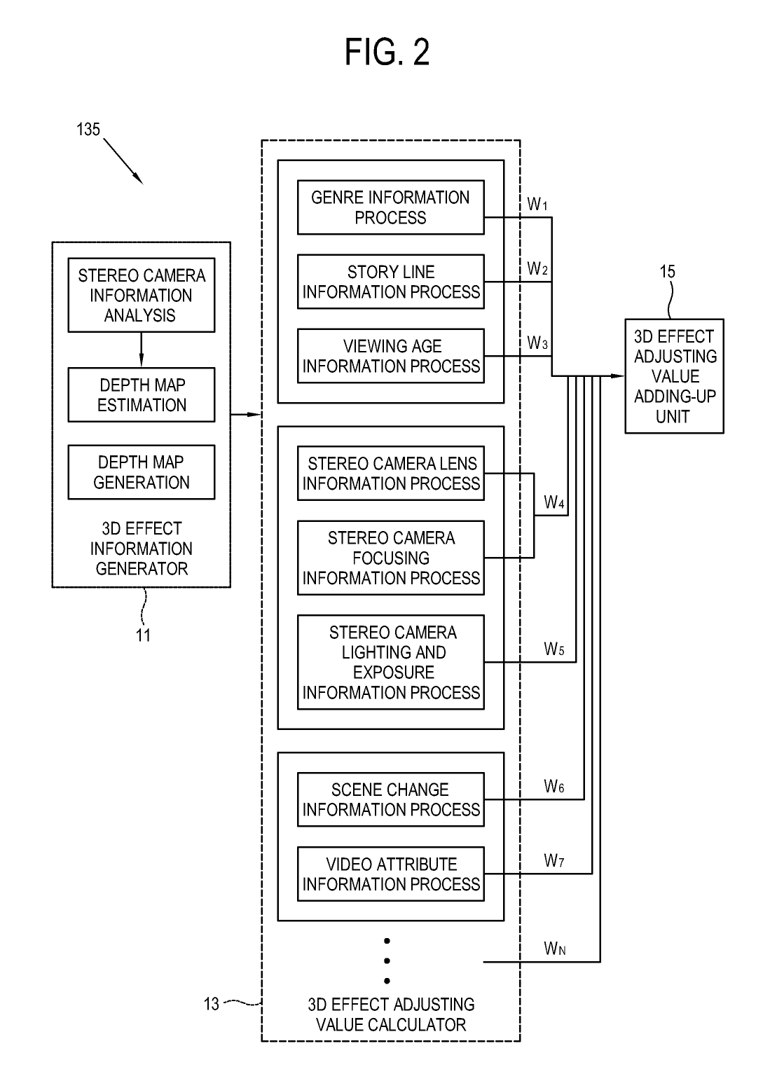

The meta data processor 135 receives at least one auxiliary data extracted by the meta data analyzer 133, and calculates at least one 3D effect adjusting value about the 3D effect information of the video signal received by the video signal receiver 110, thereby transmitting the 3D effect adjusting value to the 3D effect adjuster 137. The meta data processor 135 will be described in detail with reference to FIGS. 2 to 4.

The 3D effect adjuster 137 adjusts or renews the 3D effect information of the video signal received by the video signal receiver 110 on the basis of the 3D effect adjusting value received from the meta data processor 135, and adjusts the received video signal to have a 3D effect based on the renewed (i.e., adjusted) 3D effect information.

The display unit 140 displays an image based on a video signal output from the video signal processor 130. The video signal processor 130 performs general video processing, and the 3D video signal having the 3D effect adjusted by the 3D effect adjuster 137 is received to thereby alternately display a left-eye image and a right-eye image. The display 140 may be achieved by liquid crystal, plasma, a light-emitting diode, an organic light-emitting diode, a surface-conduction electron-emitter, a carbon nano-tube, nano-crystal, or the like various display types without any limitation.

Referring to FIGS. 2 to 4, configuration and operation of the meta data processor 135 will be described below in detail. FIG. 2 is a control block diagram of the meta data processor 135. As shown in FIG. 2, the meta data processor 135 includes a 3D effect information generator 11, a 3D effect adjusting value calculator 13, and a 3D effect adjusting value adding-up unit 135.

The 3D effect information generator 11 estimates or generates 3D effect information about a video signal received by the video signal receiver 110, and the 3D effect information includes a depth map of the video signal.

A. The 3D effect information generator 11 may estimate or generate a depth map on the basis of a related art depth map estimation or generation theory or algorithm so as to generate a 3D video signal corresponding to a received 2D video signal if an input video signal of the video signal receiver 110 is the 2D video signal.

B. The 3D effect information generator 11 may estimate a depth map on the basis of the related art depth map estimation theory by analyzing a 3D video signal if an input video signal of the video signal receiver 110 is the 3D video signal and the 3D video signal contains no depth map information.

C. The 3D effect information generator 11 may generate a depth map based on stereo camera information if an input video signal of the video signal receiver 110 is a 3D video signal and the 3D video signal contains, rather than depth information, stereo camera information in the form of meta data. The stereo camera information may contain information about at least one of the kinds of lenses (e.g., view angles according to the kinds of lenses), distance between the stereo cameras, shooting distance, focusing distance, exposure, lighting, etc. Accordingly, the 3D effect information generator 11 may calculate a depth value of an object included in a video signal by the following expression 1 on the basis of the stereo camera information:

$${L}_{d} = \frac{{L}_{b}}{{a}_{1} {a}_{2}} \\ {a}_{1} = \frac{{d}_{c}}{{d}_{e}} \\ {a}_{2} = \frac{tan \frac{β}{2}}{tan \frac{α}{2}} , \qquad [ Expression 1 ]$$

where, Ld is a position of a stereoscopic object, Lb is a shooting distance, dc is a distance between the stereo cameras, de is a distance between two eyes, α is the kind of lens or a view angle of the lens, and β is a view angle of a human. Thus, if values of elements are analyzed from the stereo camera and input to the expression 1, a position of the stereoscopic object is determined. Here, the position of the stereoscopic object is the same as a depth value of the object. Accordingly, if information about the stereo camera is given in the form of meta data, the depth value of the object can be easily calculated through the expression 1.

According to an exemplary embodiment, the 3D effect information generator 11 can estimate or generate a depth map about the video signal received through the video signal receiver 110 even though the video signal received through the video signal receiver 110 is a 2D video signal or a 3D video signal or even though the video signal contains no depth map.

The 3D effect adjusting value calculator 13 calculates a 3D effect adjusting value for adjusting 3D effect information estimated or generated by the 3D effect information generator 11 by analyzing and processing the auxiliary data received through the meta data analyzer 133.

Here, as described above, the 3D effect information includes the depth map estimated or generated with respect to the input video signal, the auxiliary data includes depth adjusting data to be usable in adjusting the depth map, and the 3D effect adjusting value includes a depth adjusting value for adjusting a depth value of the depth map. Thus, the 3D effect adjusting value calculator 13 analyzes and processes the depth adjusting data received through the meta data analyzer 133, and calculates the depth adjusting value for adjusting the depth map generated or estimated by the 3D effect information generator 11.

The 3D effect adjusting value calculator 13 calculates the depth adjusting values differently in accordance with the attributes of the depth adjusting data received from the meta data analyzer 133. For instance, the 3D effect adjusting value calculator 13 calculates the depth adjusting values differently in accordance with the attributes of the depth adjusting data as follows.

D. If the depth adjusting data received from the meta data analyzer 133 is genre information of contents, the 3D effect adjusting value calculator 13 calculates the depth adjusting values differently in accordance with the genres of the contents. For example, if the genre of the contents is melodrama, a user's immersion in the contents may decreases when the depth value is high, so that the depth adjusting value can be calculated to have a depth value lower than the depth value of the depth map estimated or generated by the 3D effect information generator 11. Also, if the genre of the contents is sports, an action movie or a war movie, the liveliness of the sports, the action movie or the war movie may be insufficient when the depth value is low, so that the depth adjusting value can be calculated to have a depth value higher than the depth value of the depth map estimated or generated by the 3D effect information generator 11.

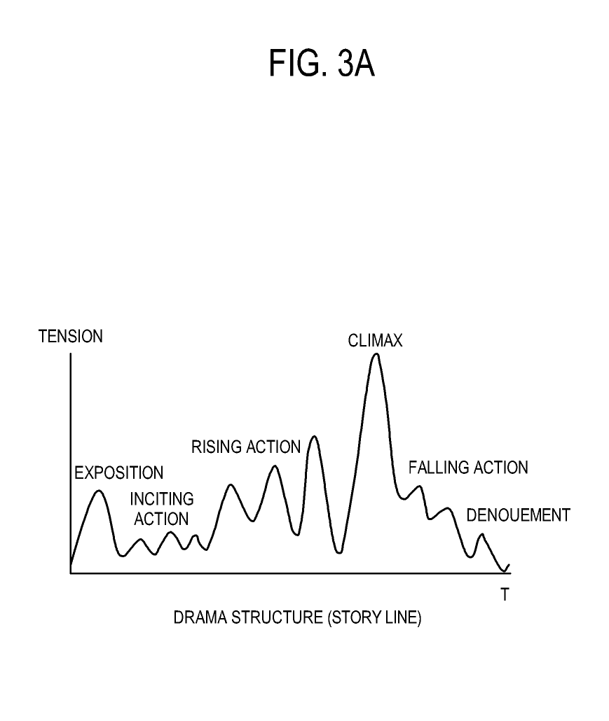

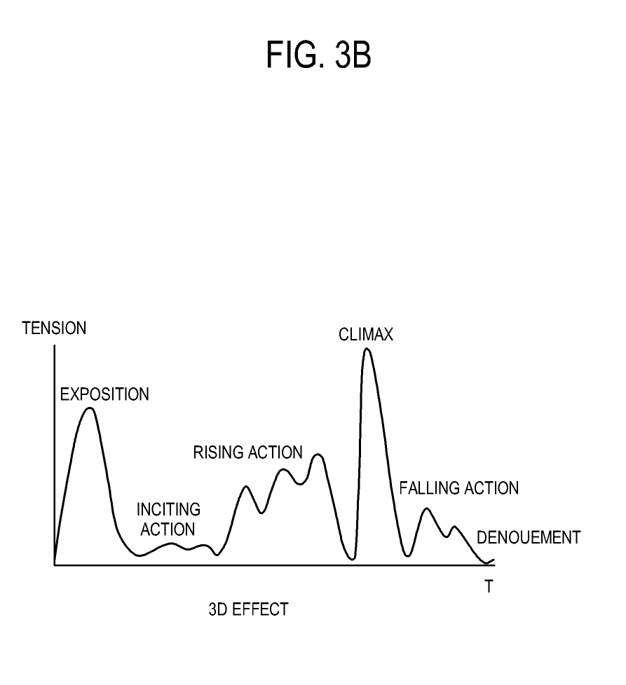

E. If the depth adjusting data received from the meta data analyzer 133 is story line information, the 3D effect adjusting value calculator 13 calculates the depth adjusting values varied in the 3D effect of the video signal depending on the story line. FIG. 3A shows the story line or drama structure of the video signal. In FIG. 3A, the story line information includes information about exposition, an inciting action, a rising action, a climax, a falling action and a denouement. As shown in FIG. 3B, the 3D effect adjusting value calculator 13 may calculate the depth adjusting value to have a depth value corresponding to an inciting action portion higher or greater by a predetermined range than the depth value based on the depth map estimated or generated by the 3D effect information generator 11, thereby arousing a viewer's curiosity and increasing the user's immersion in the inciting action portion of the video signal. Also, in order to give maximum dramatic tension to a user in a climax portion of the video signal, the 3D effect adjusting value calculator 13 calculates the depth adjusting value to have a depth value smaller by a predetermined range than the depth value based on the depth map estimated or generated by the 3D effect information generator 11 just before the climax, and then calculates the depth adjusting value to have a depth value higher by a predetermined range than the depth value based on the depth map estimated or generated by the 3D effect information generator 11 in the climax portion. Accordingly, the 3D effect adjusting value calculator 13 can calculate the depth adjusting value to have a depth value in proportion to the story line or dramatic structure of the video signal.

F. If the depth adjusting data received from the meta data analyzer 133 is viewing age information of the contents, the 3D effect adjusting value calculator 13 calculates the depth adjusting values varied in the 3D effect of the video signal depending on the viewing age information. For example, the 3D effect adjusting value calculator 13 calculates the depth adjusting value to have a depth value lower by a predetermined range than the depth value based on the depth map estimated or generated by the 3D effect information generator 11 as a viewing age rating gets lower, and calculates the depth adjusting value to have a depth value higher by a predetermined range than the depth value based on the depth map estimated or generated by the 3D effect information generator 11 as a viewing age rating gets higher.

G. If the depth adjusting data received from the meta data analyzer 133 is stereo camera information, the 3D effect adjusting value calculator 13 may receive the stereo camera information analyzed by the 3D effect information generator 11. The stereo camera information may include information about at least one of the kinds of lenses (e.g., view angles according to the kinds of lenses), distance between the stereo cameras, shooting distance, focusing distance, exposure, lighting, etc. Also, the 3D effect adjusting value calculator 13 may receive a depth value of an object calculated using the expression 1, described above, by the 3D effect information generator 11. If the depth map of the video signal is estimated by the general depth map estimation theory, the 3D effect adjusting value calculator 13 compares the depth value calculated using the expression 1 by the 3D effect information generator 11 with the depth value of the object in the estimated depth map. If the two depth values are different from each other, the depth adjusting value is calculated to make a depth value calculated using the expression 1 in the estimated depth map. The expression 1 shows the depth values derived using the real stereo camera information, so that a user can feel a 3D effect of reality from an image displayed through the display unit.

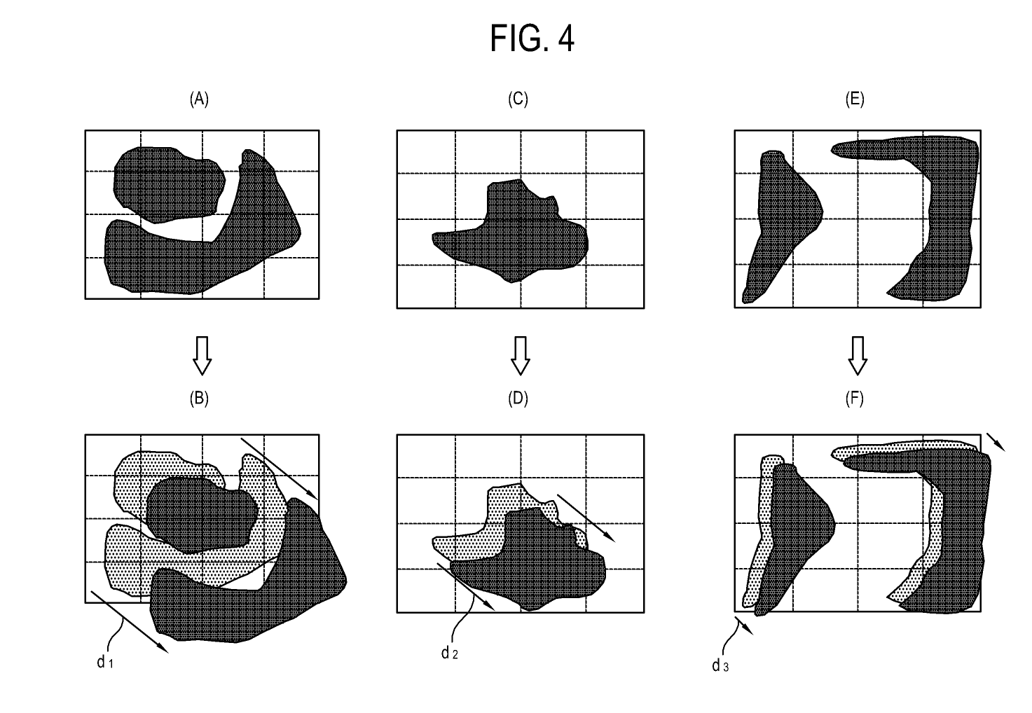

H. If the depth adjusting data received from the meta data analyzer 133 is exposure information or lighting information of the stereo camera information, the 3D effect adjusting value calculator 13 calculates the depth adjusting values varied in the 3D effect of the video signal depending on brightness of the video signal. In the dark, a human's eyesight falls and the human's view is also narrowed. Since light intensity of neighbor light sources is weak at dark, quantity of light entering the eyes has to be increased. To have such an effect, the pupils of the eyes are dilated. At this time, instead of increasing the quantity of light and distinguishing an object with small quantity of light, the eyesight falls and the view is also narrowed. Thus, a user cannot properly feel a 3D effect in a dark region of an image even though a depth value is high. Accordingly, the 3D effect adjusting value calculator 13 can calculate a depth adjusting value to make the 3D effect of the video signal vary depending on the brightness of the videos signal, which will be described with reference to FIG. 4. The 3D effect adjusting value calculator 13 can ascertain distribution of a dark region of an image on the basis of at least one of the exposure information and the lighting information of the stereo camera information, and video attribute information.

As shown in FIG. 4, if a dark region occupies most of an image (A), a human's two eyes dilate pupils to recognize an object in a dark scene, and thus the human's eyesight falls and s/he has narrow view. In this case, a user cannot satisfactorily feel the 3D effect even though the depth value based on the depth map estimated or generated in the 3D effect information generator 11 is high in the dark region. Thus, if most of the whole image region is dark, the 3D effect adjusting value calculator 13 can calculate a depth adjusting value to have a depth value d1 greater by a predetermined range than the depth value based on the depth map estimated or generated by the 3D effect information generator 11 (refer to (B) of FIG. 4).

If a dark region of an image occupies a center region of a screen (C), the 3D effect adjusting value calculator 13 can calculate a depth adjusting value to have a depth value d2 greater by a predetermined range than the depth value based on the depth map estimated or generated by the 3D effect information generator 11, but smaller by a predetermined range than the depth value d1 of (B) in the dark region (refer to (D) of FIG. 4). Thus, the depth value d2 of (D) may be smaller than the depth value d1 of (B).

If a dark region of an image occupies an edge region of a screen (E), the 3D effect adjusting value calculator 13 can calculate a depth adjusting value to have a depth value d3 greater by a predetermined range than the depth value based on the depth map estimated or generated by the 3D effect information generator 11 but smaller by a predetermined range than the depth value d2 of (D) in the dark region (refer to (F) of FIG. 4). Thus, the depth value d3 of (F) may be smaller than the depth value d2 of (D).

I. If the depth adjusting data received from the meta data analyzer 133 is video attribute information of a video signal, the 3D effect adjusting value calculator 13 calculates the depth adjusting values varied in the 3D effect of the video signal depending on video attributes. The video attribute information may include brightness, contrast, color temperature, etc., of the video signal. Among the video attribute information, the color temperature is as follows. According to a human's recognition, an object in a region having a low color temperature (reddish color) looks more projected than real, and an object in a region having a high color temperature (bluish color) looks more recessed than the real. Thus, the 3D effect adjusting value calculator 13 analyzes distribution of the color temperature on the basis of the video attribute information, and calculates a depth adjusting value to have a depth value smaller by a predetermined range than the depth value based on the depth map estimated or generated by the 3D effect information generator 11 in the region having the low color temperature. On the other hand, the 3D effect adjusting value calculator 13 calculates a depth adjusting value to have a depth value greater by a predetermined range than the depth value based on the depth map estimated or generated by the 3D effect information generator 11 in the region having the high color temperature.

It is possible to receive one or a plurality of auxiliary data from the meta data analyzer 133. At this time, the auxiliary data may include the depth adjusting data usable in adjusting the depth map of the input video signal. Thus, there may also be one or a plurality of depth adjusting data. If the plurality of depth adjusting data is received from the meta data analyzer 133, the 3D effect adjusting value calculator 13 analyzes and processes the plurality of depth adjusting data as described above, and calculates a plurality of depth adjusting values, thereby transmitting the calculated values to the 3D effect adjusting value adding-up unit 15.

The 3D effect adjusting value adding-up unit 15 may receive the depth adjusting value from the 3D effect adjusting value calculator 13. If one depth adjusting value is received, the one depth adjusting value is directly transmitted to the 3D effect adjuster 137. If a plurality of depth adjusting values are received, the 3D effect adjusting value adding-up unit 15 weights the plurality of depth adjusting values and calculates an added-up final depth adjusting value, thereby transmitting the final depth adjusting value to the 3D effect adjuster 137.

Referring back to FIG. 2, the 3D effect adjusting value calculator 13 calculates a plurality of depth adjusting values W1, W2, W3, W4, W5, W6, W7, . . . , WN from a plurality of depth adjusting data (i.e., N data), and transmits the calculated plurality of depth adjusting values to the 3D effect adjusting value adding-up unit 15. The 3D effect adjusting value adding-up unit 15 receives the plurality of depth adjusting values and may derive the final depth adjusting value through the following expression 2. Eventually, a plurality of depth adjusting values are weighted and added up.

$$3 {D}_{Effect} = \frac{{\sum }_{n = 1}^{N} {w}_{n} 3 {D}_{Effect} ( n )}{{\sum }_{n = 1}^{N} {w}_{n}} \text{?} \\ \text{?} \text{indicates text missing or illegible when filed} \qquad [ Expression 2 ]$$

If the 3D effect adjusting value adding-up unit 15 calculates the final depth adjusting value through the expression 2 and transmits the calculated final depth adjusting value to the 3D effect adjuster 137, the 3D effect adjuster 137 renews (i.e., adjusts) the depth map estimated or generated by the 3D effect information generator 11 on the basis of the final depth adjusting value, so that the 3D effect of the 3D video signal can be adjusted using the renewed depth map. The video signal of which the 3D effect is adjusted may be transmitted to the display unit 140.

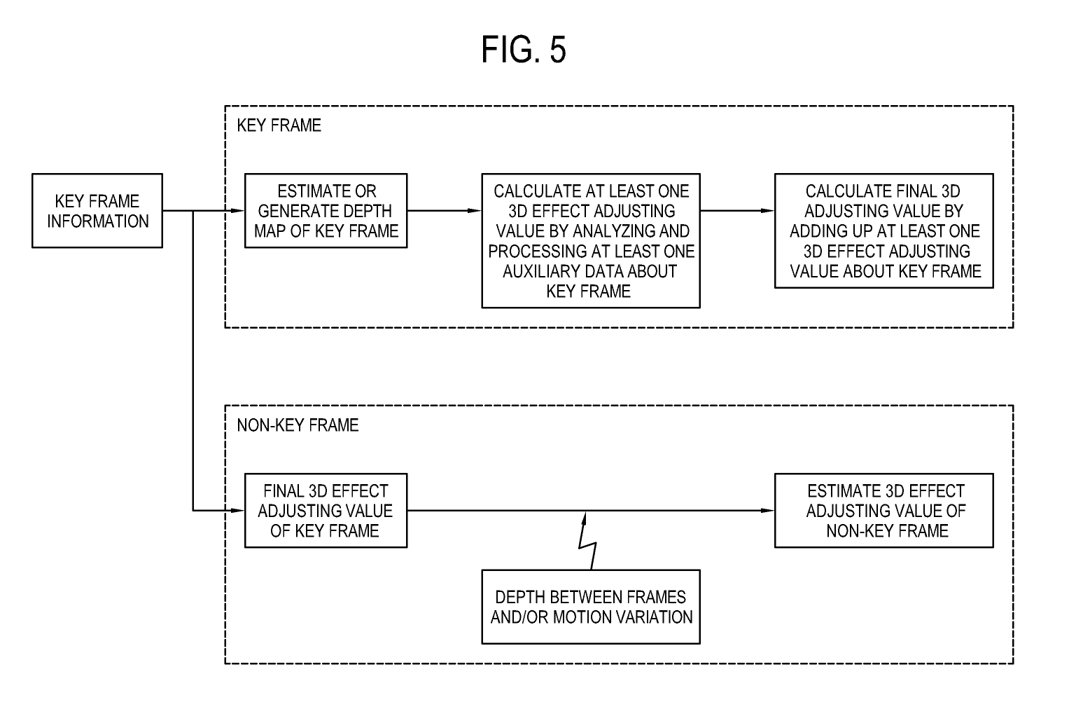

FIG. 5 is a view showing still another exemplary embodiment of the processing operation of the meta data processor of FIG. 2, which shows the processing operation when receiving key frame information as the meta data.

As shown in FIG. 5, if the meta data about the input video signal contains the key frame information of the video signal, the meta data processor 135 receives the key frame information from the meta data analyzer 133.

Below, the operation of the meta data processor 135 with regard to the key frame will be described. The 3D effect information generator 11 of the meta data processor 135 may further receive at least one auxiliary data about the key frame from the meta data analyzer 133. Thus, on the basis of the at least one auxiliary data about the key frame, the depth map is generated by the stereo camera information analysis or estimated by the general depth map estimation theory. At this time, the operation of the 3D effect information generator 11 is performed by the same or similar methods as described in exemplary embodiments in accordance with A to C described above. The 3D effect adjusting value calculator 13 of the meta data processor 135 may further receive at least one auxiliary data about the key frame from the meta data analyzer 133. Thus, using the at least one auxiliary data received with regard to the key frame, the 3D effect adjusting value can be calculated by the same or similar methods as described in exemplary embodiments in accordance with D to I described above. If a plurality of 3D effect adjusting values are calculated, the 3D effect adjusting value adding-up unit 15 adds up the plurality of 3D effect adjusting values and derives the final 3D effect adjusting value about the key frame.

Regarding a frame (i.e., a non-key frame) besides the key frame, the 3D effect adjusting value calculator 13 of the meta data processor 135 may estimate the 3D effect adjusting value for a non-key frame on the basis of the final 3D effect adjusting value for the key frame. At this time, using a difference value in motion information, a difference value in a depth value, a difference value in an image pixel, etc., between the key frames and the non-key frame, a 3D effect adjusting value of the non-key frame can be estimated on the basis of the 3D effect adjusting value of the key frame. In this case, the 3D effect adjusting value calculator 13 advantageously does not have to calculate the 3D effect adjusting value with regard to all frames. The difference value in motion information, the difference value in a depth value, the difference value in an image pixel, etc., between the key frames and the non-key frame may also be included in the meta data, or may be estimated by the video signal processor 130.

If the key frame information of the video signal is not included in the meta data about the input video signal, the 3D effect adjusting value calculator 13 may calculate the 3D effect adjusting value by the same or similar methods as described in exemplary embodiments in accordance with D to I described above on the basis of the auxiliary data of the video signal with respect to all frames.

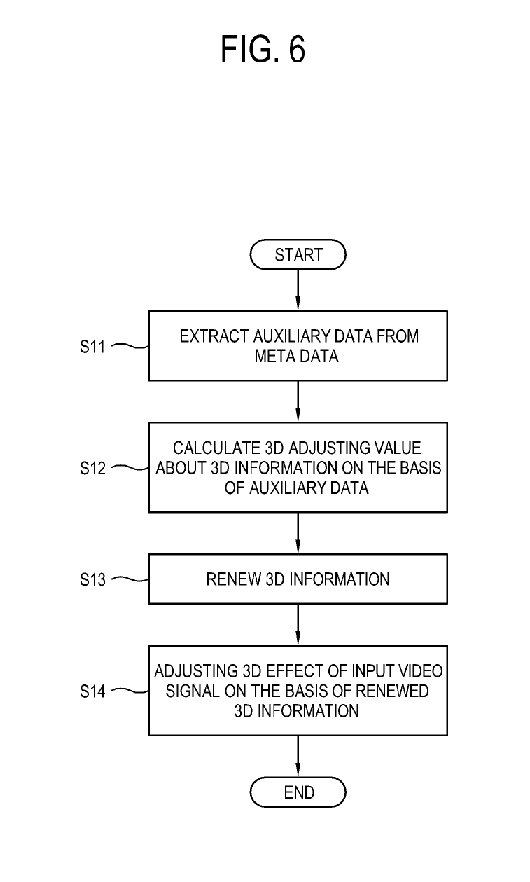

FIG. 6 is a flowchart showing a control operation of the 3D image processing apparatus of FIG. 1.

As shown therein, the meta data analyzer 133 of the 3D image processing apparatus 100 analyzes the meta data about the input video signal, and extracts the auxiliary data (operation S11). As described above, if the meta data is contained in the video signal, the meta data can be extracted from the video signal and used. Also, the meta data may be received separately from the video signal. The auxiliary data includes the depth adjusting data usable in adjusting the depth map of the video signal. There may be a plurality of auxiliary data. The auxiliary data may include at least one of content information corresponding to the input video signal, stereo camera information about the input video signal, and image-related information about the input video signal.

The meta data processor 135 calculates the 3D effect adjusting value about the 3D effect information on the basis of the extracted auxiliary data (operation S12). The 3D effect information contains the depth map about the input video signal, and the 3D effect adjusting value contains the depth adjusting value for adjusting the depth map. When receiving the video signal containing no depth map, the 3D effect information generator 11 of the meta data processor 135 may estimate the depth map about the input video signal through the general depth map estimation theory or generate the depth map through the meta data. If a plurality of auxiliary data is received from the meta data analyzer 133, the plurality of auxiliary data is analyzed to calculate respective 3D effect adjusting values, and the plurality of 3D effect adjusting values are weighted and added up, thereby calculating the final 3D effect adjusting value.

When receiving the 3D effect adjusting value, the 3D effect adjuster 137 of the meta data processor 135 renews (i.e., adjusts) the 3D effect information on the basis of the received 3D effect adjusting value (operation S13), and adjusts the 3D effect of the input video signal on the basis of the renewed 3D effect information (operation S14).

As described above, according to an exemplary embodiment, a depth map of an input video signal is adjusted in accordance with attributes of various kinds of meta data about a video signal, so that a 3D effect to be recognized by a user can be adjusted in detail, thereby maximizing the 3D effect of the input video signal.

While not restricted thereto, an exemplary embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, while not required in all aspects, one or more units of the 3D image processing apparatus 130 may include a processor or microprocessor executing a computer program stored in a computer-readable medium.

Although a few exemplary embodiments have been shown and described, it will be appreciated by those skilled in the art that changes may be made in these exemplary embodiments without departing from the principles and spirit of the inventive concept, the scope of which is defined in the appended claims and their equivalents.

What is claimed is:

1. A three-dimensional (3D) image processing apparatus comprising:
a meta data analyzer which analyzes meta data about an input video signal and extracts, from the meta data, auxiliary data usable in adjusting 3D effect information of the input video signal;
a meta data processor which calculates a 3D effect adjusting value for adjusting the 3D effect information according to the extracted auxiliary data; and
a 3D effect adjuster which adjusts the 3D effect information according to the calculated 3D effect adjusting value, and adjusts the input video signal to have a 3D effect based on the adjusted 3D effect information.

2. The 3D image processing apparatus according to claim 1, wherein the meta data processor calculates the 3D effect adjusting value in accordance with an attribute of the auxiliary data.

3. The 3D image processing apparatus according to claim 1, wherein the meta data processor calculates a plurality of 3D effect adjusting values corresponding to a plurality of auxiliary data extracted, from the meta data, by the meta data analyzer, calculates a final 3D effect adjusting value by weighting and adding the calculated plurality of 3D effect adjusting values, and transmits the calculated final 3D effect adjusting value to the 3D effect adjuster.

4. The 3D image processing apparatus according to claim 1, wherein the auxiliary data comprises at least one of content information corresponding to the input video signal, stereo camera information about the input video signal, and image-related information about the input video signal.

5. The 3D image processing apparatus according to claim 4, wherein the content information comprises at least one of genre information about content of the input video signal, story line information about the content, and viewing age information about the content.

6. The 3D image processing apparatus according to claim 4, wherein the stereo camera information comprises at least one of distance information between stereo cameras, lens information of a stereo camera, focusing information of a stereo camera, lighting information of a stereo camera, and exposure information of a stereo camera.

7. The 3D image processing apparatus according to claim 4, wherein the image-related information comprises at least one of scene change information of the input video signal, key frame information of the input video signal, video attribute information of the input video signal, and minimum and maximum depth value information of the input video signal.

8. The 3D image processing apparatus according to claim 7, wherein the auxiliary data comprises the stereo camera information and the meta data processor generates a depth map of the input video signal on the basis of the stereo camera information.

9. The 3D image processing apparatus according to claim 7, wherein the auxiliary data comprises the key frame information, and the meta data processor calculates a 3D effect adjusting value of a key frame and estimates a 3D effect adjusting value of a non-key frame according to the calculated 3D effect adjusting value of the key frame.

10. The 3D image processing apparatus according to claim 1, wherein:
the 3D effect information comprises a depth map of the input video signal;
the auxiliary data comprises depth adjusting data usable in adjusting the depth map; and
the auxiliary data adjusting value comprises a depth adjusting value for adjusting the depth map.

11. A method of adjusting a three-dimensional (3D) effect of a 3D image processing apparatus, the method comprising:
analyzing meta data about an input video signal and extracting, from the meta data, auxiliary data usable in adjusting 3D effect information of the input video signal;
calculating a 3D effect adjusting value for adjusting the 3D effect information according to the extracted auxiliary data; and
adjusting the 3D effect information according to the calculated 3D effect adjusting value, and adjusting the input video signal to have a 3D effect based on the adjusted 3D effect information.

12. The method according to claim 11, wherein the calculating the 3D effect adjusting value comprises calculating the 3D effect adjusting value in accordance with an attribute of the auxiliary data.

13. The method according to claim 11, wherein the calculating the 3D effect adjusting value comprises calculating a plurality of 3D effect adjusting values corresponding to a plurality of auxiliary data extracted in the extracting the auxiliary data, and calculating a final 3D effect adjusting value by weighting and adding the calculated plurality of 3D effect adjusting values.

14. The method according to claim 11, wherein the auxiliary data comprises at least one of content information corresponding to the input video signal, stereo camera information about the input video signal, and image-related information about the input video signal.

15. The method according to claim 14, wherein the content information comprises at least one of genre information about content of the input video signal, story line information about the content, and viewing age information about the content.

16. The method according to claim 14, wherein the stereo camera information comprises at least one of lens position information of a stereo camera, focusing information of a stereo camera, lighting information of a stereo camera, and exposure information of a stereo camera.

17. The method according to claim 14, wherein the image-related information comprises at least one of scene change information of the input video signal, key frame information of the input video signal, video attribute information of the input video signal, and minimum and maximum depth value information of the input video signal.

18. The method according to claim 16, further comprising generating a depth map of the input video signal on the basis of the stereo camera information, wherein the auxiliary data comprises the stereo camera information.

19. The method according to claim 17, wherein the calculating the 3D effect adjusting value comprises calculating a 3D effect adjusting value of a key frame and estimating a 3D effect adjusting value of a non-key frame according to the calculated 3D effect adjusting value of the key frame, wherein the auxiliary data comprises the key frame information.

20. The method according to claim 11, wherein:
the 3D effect information comprises a depth map of the input video signal;
the auxiliary data comprises a depth adjusting data usable in adjusting the depth map; and
the auxiliary data adjusting value comprises a depth adjusting value for adjusting the depth map.

21. The method according to claim 11, further comprising receiving the meta data separately from the input video signal.

22. A method of adjusting a three-dimensional (3D) effect of a 3D image processing apparatus, the method comprising:
calculating a 3D effect adjusting value for adjusting 3D effect information of a video signal according to auxiliary data comprised in meta data corresponding to the video signal; and
adjusting the 3D effect information according to the calculated 3D effect adjusting value, and adjusting the input video signal to have a 3D effect based on the adjusted 3D effect information.

23. A computer readable recording medium having recorded thereon a program executable by a computer for performing the method of claim 11.

24. A computer readable recording medium having recorded thereon a program executable by a computer for performing the method of claim 22.
